(19) United States
(12) Patent Application Publication
(10) Pub. No.: US 2011/0211352 A1
(43) Pub. Date: Sep. 1, 2011

(54) Lighting Device

(75) Inventor: Fabian Reingruber, Munchen (DE)

(73) Assignee: OSRAM GESELLSCHAFT MIT BESCHRANKTER HAFTUNG, MUNICH (DE)

(21) Appl. No.: 13/059,742

(22) PCT Filed: Jul. 21, 2009
(86) PCT No.: PCT/EP09/59345

§ 371 Date: May 18, 2011

(30) Foreign Application Priority Data
Aug. 22, 2008 (DE) 10 2008 039 365.7

(51) Int. Cl. F21S 4/00

(52) U.S. Cl. 362/249.02; 362/249.01

(57) ABSTRACT

A lighting device comprising: (1;18;22;24;27) at least one lighting means; (2), a power-supply unit (10) for the at least one lighting means; (2), and a cooling body (6) for cooling the at least one lighting means; (2), wherein the at least one lighting means (2) is secured to the cooling body (6) and separated from the power-supply unit (10) by the cooling body (6), and wherein the power-supply unit (10) has an electrically insulating cap (17;19;23;25;29) separating the power-supply unit (10) from the cooling body (6).

The invention relates to a lighting device having at least one lighting means, a power-supply unit for the at least one lighting means, and having a cooling body for cooling the at least one lighting means.

One of the main problems encountered in reducing the size of luminaires having light-emitting diodes is posed by the distances requiring to be maintained between an associated power supply's primary and secondary side. Their separation is imperative because the light-emitting diodes are located on the cooling body and hence usually on a touchable metal body in an electrically conducting manner. Typically all primary components as well as the transformer core count as belonging to the primary side. The necessary distances between the components on the primary and secondary side are, for example, according to DIN EN 60598-1 or, as the case may be, VDE 0711-1 6.5 mm (air clearance) and 5 mm (creepage distance). Said distances have hitherto been maintained mostly by suitably distancing the primary from the secondary side, particularly from a cooling body, which, though, requires a relatively large type of construction.

The object of the present invention is to provide a compact lighting device having a high degree of electric insulation between the primary and secondary side.

Said object is achieved by means of a lighting device as claimed in claim 1. Preferred embodiments are indicated particularly in the dependent claims.

The lighting device has at least one lighting means (for example a gas-discharge lamp or light-emitting diode, LED) as well as a power-supply unit for powering the at least one lighting means. The lighting device furthermore has a cooling body for cooling the at least one lighting means. The cooling body can be one that cools actively or passively. The at least one lighting means is secured to the cooling body for dissipating heat and separated from the power-supply unit by the cooling body. In other words the at least one lighting means and the power-supply unit are arranged on opposite sides of at least one cooling-body region. The power-supply unit has an electrically insulating cover cap separating the power-supply unit from the cooling body.

Firstly a directly opposite arrangement (with no electric insulation or with only an air clearance) is prevented by means of the cover cap. The shortest air clearance or creepage distance between the primary side (power-supply unit) and cooling body will then extend around the cover cap. Because the cover cap has a side wall, said clearance/distance will be lengthened, as a result of which an improved electric insulation between the primary and secondary side can be provided and hence a more stringent safety requirement met, for example with reference to protection classes I to III according to DIN EN 60598-1. A more compact design will simultaneously be made possible in a simple manner because the power-supply unit can be brought closer to the cooling body.

For achieving the lighting means in a simple way, preference can be given to a lighting device in which the cooling body has a feed-through for at least one connecting lead between the power-supply unit and the at least one lighting means.

Preference can be given to a lighting device in which the cover cap also has at least one feed-through, particularly a frontal feed-through, that extends through the cooling body's feed-through. An arrangement will be provided thereby in which the connecting lead(s) can be routed directly to the cooling body's front side with little installation effort and no proneness to wear-and-tear. The length of the air clearance will then depend substantially on how long the cover cap's feed-through extends. It will preferably then be longer, at least by the thickness of the cooling body's feed-through, than if there were no cover cap. The extension is preferably tubular.

For simple mounting and sealing, preference can be given to a lighting device in which the cover cap is attached rigidly or loosely to a receptacle for the power-supply unit. The contact surfaces can also be glued or welded together.

For simply producing and attaining a high degree of imperviousness, preference can be given to a lighting device in which the cover cap is joined as a single piece to a—particularly tubular—receptacle for the power-supply unit. A plastic, for example PVC, will then be preferred as the material as it is easily injection-molded.

Particularly for ensuring a long air clearance or creepage distance, preference can be given to a lighting device in which the cover cap has a closed shape, meaning has no feed-through with a circumferential edge. The connecting lead(s) will then be routed around the edge of the cover and ducted externally on the cover to the at least one lighting means, preferably through a feed-through through the cooling body.

For simple mounting, preference can, though, be given also to a lighting device in which the cover cap has been plugged at least partially over the power-supply unit. The cover cap can in particular be plugged by an open side over an object requiring to be covered and will cover it frontally (in terms of the emplacing direction) and by means of a—mostly circumferential—side wall also at least partially laterally.

Preference is given to a lighting device in which the power-supply unit has at least one printed-circuit board fitted with at least one transformer and the cover cap has been plugged at least partially over the transformer. The insulating cover cap is in the case of the board design preferably plugged over the transformer and board in such a way as to be clamped into position. Power-supply units that do not have a transformer can, though, also be used provided they have a primary side and secondary side, in particular a secondary side that is electrically isolated from the primary side.

Preference is given also to a lighting device having at least one connecting lead between the power-supply unit and the at least one lighting means for feeding the lighting means. The connecting lead can therein be connected directly to the at least one lighting means; electric or electronic elements can alternatively be connected intermediately, for example a driver for controlling the at least one lighting means, in particular an LED.

The connecting lead is preferably connected to the power-supply unit in the space covered by the cover because the air clearance and creepage distance between the lead's primary-side terminal and the cooling body will then be lengthened.

A basically dish-shaped cover cap is preferred. Variations of different kinds are therein conceivable such as, for instance, a flat or curved base, a straight or curving side wall, a rounded (circular, oval etc.) or angular, for example cuboidal, contour as viewed from above, and so forth.

The cover cap is made preferably of a flexible material to make it easier to plug on. The cover cap can be fixed into place by means of a press fit, but also by other means such as gluing or latching and so forth. Of course the cover cap can be embodied also as being non-flexible, for example it can be made of PVC.

For reduced proneness to faults, preference can be given to a lighting device in which the cover cap is fitted with an anti-turning means.

For reduced proneness to faults, preference can be given also to a lighting device in which the cover cap is fitted with a means for fixing the power-supply unit in place.

The lighting means is basically unrestricted and can have a gas-discharge lamp though also an incandescent lamp. What, though, is preferred is a lighting device in which the lighting means has at least one semiconductor light source such as a diode laser, though particularly a light-emitting diode.

The lighting means can take the form of, for instance, an LED module having one light-emitting diode or a plurality of light-emitting diodes. The individual light-emitting diodes can each shine in a single color or in multiple colors, for example white. When there is a plurality of light-emitting diodes they can for example shine in the same color (a single color or multiple colors) and/or different colors. Thus an LED module may have a plurality of single LEDs (‘LED cluster’) which together can produce a white mixed light, for example ‘cold white’ or ‘warm white’. For producing a white mixed light the LED cluster preferably includes light-emitting diodes that shine in the primary colors red (R), green (G), and blue (B). Single colors or a plurality thereof can therein also be produced simultaneously by a plurality of LEDs; thus combinations RGB, RRGB, RGGB, RGBB, RGGBB etc. are possible. The color combination is not however limited to R, G, and B (and A). For producing a warm white color tone there can also be for example one or more amber-colored LEDs ‘amber’ (A). LEDs having different colors can also be controlled such that the LED module will emit light in a tunable RGB color range. For producing a white light from a mixture of blue and yellow light it is possible also to use blue. LED chips furnished with a fluorescent material using, for example, surface-mount technology, for example ThInGaN technology. An LED module will then also be able to have a plurality of white single chips, as a result of which a simple scalability of the light stream can be achieved. The single chips and/or the modules can be fitted with suitable optics for beam guiding, for example Fresnel lenses or collimators and so forth. A plurality of similar or dissimilar LED modules can be located on one contact, for example a plurality of similar LED modules on the same substrate. Instead of or in addition to inorganic light-emitting diodes based on, for instance, InGaN, InGAlP, or AlInGaP, organic LEDs (OLEDs) can generally also be used. For example diode lasers can also be used as semiconductor light sources.

In the following figures the invention is described schematically in more detail with the aid of exemplary embodiments. Elements that are identical or have an identical effect can for greater clarity therein be assigned the same reference numerals.

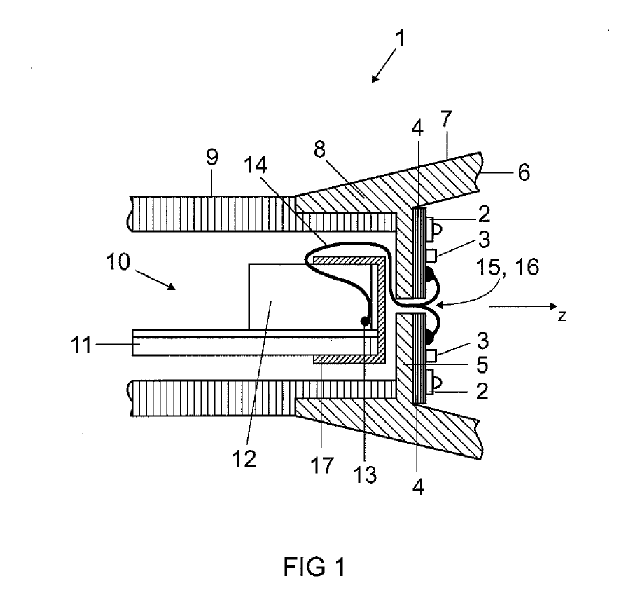

FIG. 1 is a sectional side view of an LED lighting device according to a first embodiment;

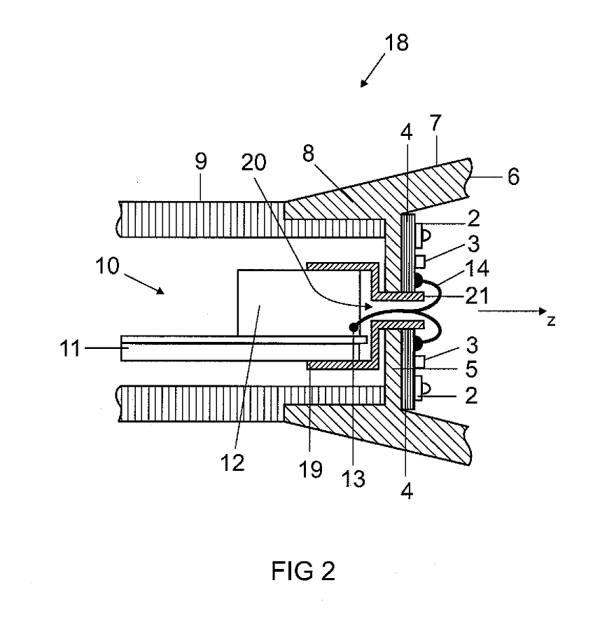

FIG. 2 is a sectional side view of an LED lighting device according to a second embodiment;

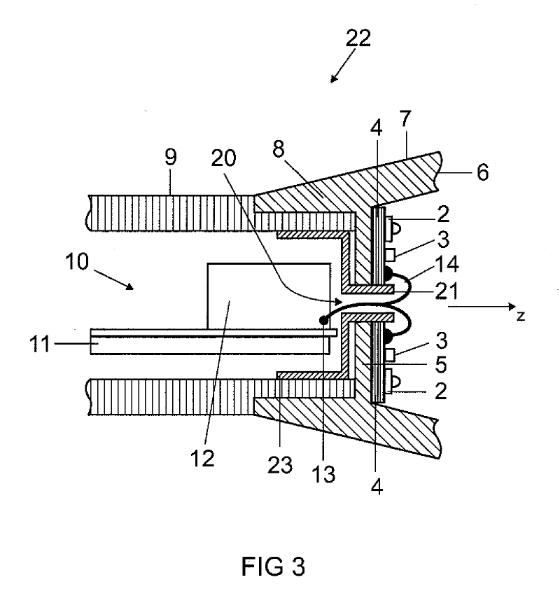

FIG. 3 is a sectional side view of an LED lighting device according to a third embodiment;

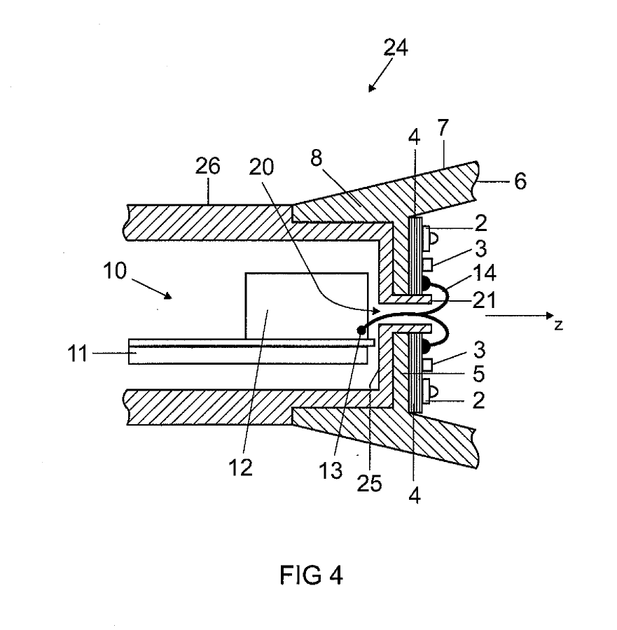

FIG. 4 is a sectional side view of an LED lighting device according to a fourth embodiment;

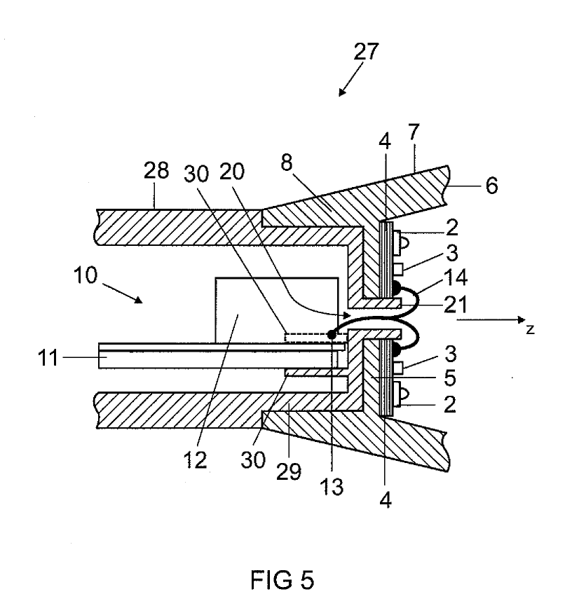

FIG. 5 is a sectional side view of an LED lighting device according to a fifth embodiment.

FIG. 1 shows an LED lighting device 1 according to a first embodiment. The device has a plurality of light-emitting diodes 2 mounted along with associated electronic components 3 on a top side of a board 4. The electronic components provide at least one driver for controlled feeding of the light-emitting diodes. For dissipating heat from light-emitting diodes 2 and electronic components 3 board 4 is embodied as a metal-core board applied with its underside against a flat contact area 5 of a metallic cooling body 6. Contact area 5 is surrounded laterally by a circumferential side wall 7 which (to the right of the contact area 5, in the z direction) with the contact area 5 forms a cup-shaped reflector for the light radiated from LEDs 2. Below (in terms of the z direction) contact area 5, circumferential side wall 7 forms a connecting region 8 of an electrically insulating, at least terminally tubular plastic body 9 having a bowed (for example round or oval) or angular (for example square or n-sided (n≧5) profile. Plastic body 9 serves as a receptacle for a power-supply unit 10 and accommodates at least a part of power-supply unit 10. Power-supply unit 10 here has a printed-circuit board 11 with a transformer 12 secured on a top side thereof. Trans-former 12 is located on the outer edge of printed-circuit board 11 situated directly opposite contact area 5 of cooling body 6. Secondary-side terminal 13 of transformer 12 is in particular located in the vicinity of the edge. Connected to secondary-side terminal 13 is a connecting lead 14 which is ducted through a central feed-through 15 in contact area 5 of cooling body 6 and through a directly following feed-through 16 in metal-core board 5 to the top side thereof to the electric terminal.

The air clearance between the primary side of power supply 10 extending up to the outermost end opposite the cooling body's contact area 5 would without any further measures correspond roughly to the distance of power-supply unit 10 from contact area 5. However, proceeding from the end of the cooling-body side an electrically insulating cover cap 17 has been plugged over power-supply unit 10 sufficiently far to reach partially across transformer 12 and printed-circuit board 11. Cover cap 17 thereby separates power-supply unit 10 from cooling body 6 so that the primary and secondary side are also mutually separated. With cover cap 17 having a closed shape, connecting lead 14 has to be routed around it. It will in that way be possible to maintain both the requisite air clearance and the creepage distance even if cooling body 6 is situated directly next to transformer 12. The secondary-side components are located on metal-core board 4 with LEDs 2. The thus size-reduced structural design will make it possible in particular to comply with standards relating to structural size.

FIG. 2 shows an LED lighting device 18 according to a second embodiment. Cover cap 19 has in contrast to the first embodiment shown in FIG. 1 a feed-through (channel) 20 located centrally (frontally in the emplacing direction counter to the z axis) on the base. Feed-through 20 has a tubular extension 21 extending through feed-through 15 of cooling body 6. Connecting lead 14 can now be routed through feed-through 20 to the top side of metal-core board 4 instead of around the cap. A design that is laterally (perpendicularly to the z axis) more compact can be achieved thereby. The air clearance and creepage distance are here calculated substantially from the distance of power-supply unit 10 from feed-through 20, the length of feed-through 20 (along the z axis), and the distance of the opening of the feed-through from metal-core board 4.

For producing lighting device 18, cover cap 19 can be secured to power-supply unit 20 or cooling body 6 before power-supply unit 20 and cooling body 6 are brought together.

FIG. 3 shows a lighting device 22 in which, in contrast to lighting device 18 shown in FIG. 2, cover cap 23 has not been plugged over power-supply unit 10 but is instead secured by the outside of its side wall to receptacle 9—for power-supply unit 10—embodied as a plastic body. Cover cap 23 can for example be loosely or rigidly seated in tubular receptacle 9 and/or be glued thereto or latched into position.

FIG. 4 shows a lighting device 24 in which cover cap 25 is now embodied as being a single piece with receptacle 26 and thus forms a partial region thereof, here a partial region on the end side. Cover cap 25 along with receptacle 26 can be produced by, for example, injection-molding plastic, for example PVC. As in the embodiments shown in FIG. 2 and FIG. 3, cover-cap region 25 has a feed-through 20 (along the z axis). Said embodiment has the advantage that cooling body 6 will as a result of single-piece embodying be sealed from the power-supply unit up to feed-through 20.

FIG. 5 shows a lighting device 27 similar to that shown in FIG. 4 but with cover cap 29 embodied as being a single piece with receptacle 28 now having webs 30 for fixing board 4 of power-supply unit 10 into position, with board 4 being plugged into webs 30 for fixing into position.

The present invention is of course not limited to the exemplary embodiments shown.

Thus the cap can in general be fitted with an anti-rotation means. That can be realized by means of, for example, at least one web in the cap—in particular on an outer side of the side wall—as an engaging element and by means of a mating slot in the housing as a counter engaging element, or vice versa. Other latched, plugged, clamped etc. anti-rotation means are, though, also possible, for example based also on the interaction between the cap and cooling body.

The cap can in general have a fixing means having one or more fixing elements for fixing the power-supply unit into position or, as the case may be, retaining it.

The cooling body needs only to have an electrically conducting surface and, apart from metal, can also be constructed from or coated with an electrically conducting plastic, for instance, or an electrically conducting ceramic that contains, for example, AlN.

### LIST OF REFERENCE NUMERALS

1 LED lighting device
2 Light-emitting diode
3 Electronic component
4 Metal-core board
5 Contact area
6 Cooling body
7 Side wall
8 Connecting region
9 Plastic body
10 Power-supply unit
11 Printed-circuit board
12 Transformer
13 Secondary-side terminal
14 Connecting lead
15 Feed-through
16 Feed-through
17 Cover cap
18 Lighting device
19 Cover cap
20 Feed-through
21 Tubular extension
22 Lighting device
23 Cover cap
24 Lighting device
25 Cover cap
26 Receptacle
27 Lighting device
28 Receptacle
29 Cover cap
30 Web

1. A lighting device comprising:
at least one lighting means;
a power-supply unit for the at least one lighting means; and
a cooling body for cooling the at least one lighting means;
wherein the at least one lighting means is secured to the cooling body and separated from the power-supply unit by the cooling body, and
wherein the power-supply unit has an electrically insulating cap separating the power-supply unit from the cooling body.

2. The lighting device as claimed in claim 1, wherein the cooling body has a feed-through for at least one connecting lead between the power-supply unit and the at least one lighting means.

3. The lighting device as claimed in claim 2, wherein the cover cap has at least one feed-through which extends through the feed-through of the cooling body.

4. The lighting device as claimed in claim 3, wherein the cover cap is applied against a receptacle for the power-supply unit.

5. The lighting device as claimed in claim 3, wherein the cover cap is joined as a single piece to a receptacle for the power-supply unit.

6. The lighting device as claimed in claim 1, wherein the cover cap has a closed shape.

7. The lighting device as claimed in claim 1, wherein the cover cap has been plugged at least partially over the power-supply unit.

8. The lighting device as claimed in claim 7, wherein the power-supply unit has a printed-circuit board fitted with a transformer and the cover cap has been plugged at least partially over the transformer.

9. The lighting device as claimed in claim 1, further comprising at least one connecting lead between the power-supply unit and the at least one lighting means, which lead is connected to the power-supply unit in the space covered by the cover.

10. The lighting device as claimed in claim 1, wherein the cover cap is basically dish-shaped.

11. The lighting device as claimed in claim 1, wherein the cover cap is made of a flexible material.

12. The lighting device as claimed in claim 1, wherein the cover cap is fitted with an anti-turning means.

13. The lighting device as claimed in claim 1, wherein the cover cap is fitted with a means for fixing the power-supply unit into position.

14. The lighting device as claimed in claim 1, wherein the lighting means has at least one light-emitting diode.

15. The lighting device as claimed in claim 3, wherein the feed-through is a frontal feed-through.
